(19) United States
(12) Patent Application Publication
(10) Pub. No.: US 2026/0053296 A1
(43) Pub. Date: Feb. 26, 2026

(54) FRYER

(71) Applicant: COOL FRYER CO., LTD., Yokohama-shi (JP)

(72) Inventors: Hiroshi Fukuda, Yokohama-shi (JP); Sumito Yamada, Yokohama-shi (JP); Koji Yamada, Yokohama-shi (JP)

(73) Assignee: COOL FRYER CO., LTD., Yokohama-shi (JP)

(21) Appl. No.: 18/923,998

(22) Filed: Oct. 23, 2024

(30) Foreign Application Priority Data
Aug. 21, 2024 (JP) 2024-140040

(51) Int. Cl. A47J 37/12

(52) U.S. Cl. CPC A47J 37/1276

(57) ABSTRACT

Provided is a fryer that can prevent oxidative deterioration of a frying oil even in repeated use of the frying oil. The fryer includes: an upper oil tank in which frying is performed; a lower oil tank forcibly cooled by a water-cooling jacket; a reserve tank configured to store the frying oil discharged from the lower oil tank; and a return flow path for feeding the frying oil in the reserve tank into the lower oil tank. The reserve tank includes a filter provided at a top thereof and configured to remove fried scraps from the frying oil, and a bottom plate in the reserve tank is inclined toward a deepest portion serving as a reservoir for the frying oil. A suction pipe leading to the return flow path is arranged in the reservoir, and a distal end of the suction pipe is arranged at a distance from the bottom plate of the reserve tank.

### BACKGROUND OF THE INVENTION

### 1. Field of the Invention

The present invention relates to a fryer to be used for cooking fried food, and more particularly, to a fryer including a heater provided in a middle of an oil tank in a depth direction of the oil tank and configured to heat a frying oil.

### 2. Description of the Related Art

Hitherto, as the fryer of this type, there is known a fryer including an oil tank configured to store a frying oil therein, and a heater arranged in a middle of the oil tank in a depth direction of the oil tank. An upper oil tank above the heater is provided as a high-temperature section, and fried food is cooked in the upper oil tank. Meanwhile, a lower oil tank below the heater is provided as a low-temperature section, and moisture and fried scraps formed in the oil during cooking of fried food are sunken into the lower oil tank to be collected.

In particular, in JP 5901624 B2, there is disclosed a fryer in which a water-cooling jacket that covers the entire lower oil tank from the outside is provided to forcibly cool the lower oil tank. In this fryer, an oil temperature in the lower oil tank is suppressed to 60 degrees Celsius or less by a cooling effect of the water-cooling jacket, and hence moisture released from a food material in the high-temperature upper oil tank is retained in the lower oil tank without vaporizing when the released moisture sinks in the lower oil tank due to a difference in specific gravity from the frying oil. Thus, oil spatter caused by boiling of the frying oil is suppressed, and hence sinking of fried scraps in the lower oil tank can be facilitated. In addition, oil stains in a kitchen can be reduced. Further, vaporization of the moisture in the oil tank is prevented as much as possible, and hence there have been recognized effects that deterioration of the frying oil due to oxidation can be effectively prevented, and that a replacement cycle of the frying oil can be prolonged.

In many professional-use fryers that fry a large amount of food continuously, an oil recovery tank is provided below the oil tank inside a housing in order to enable cleaning of the oil tank and repeated use of the frying oil. For example, after the end of a day's cooking work, a total volume of the frying oil in the oil tank is discharged into the oil recovery tank, and thus the empty oil tank can be cleaned. Then, after cleaning is completed, the frying oil in the oil recovery tank is returned to the oil tank, and thus frying with repeated use of the frying oil can be performed.

In this regard, in the fryer disclosed in JP 5901624 B2, as described above, the moisture released from the food material is easily retained in the lower oil tank without vaporizing. This means that a large amount of moisture is contained in the frying oil discharged from the oil tank into the oil recovery tank. Thus, when the total volume of the frying oil in the oil recovery tank is returned to the oil tank after the cleaning work is completed, even the moisture collected in the frying oil is returned to the oil tank. The frying oil is stirred during the process of feeding the frying oil from the oil recovery tank into the oil tank, and hence there is a fear in that when the frying oil in the oil tank is heated again from that state, the moisture mixed in the frying oil vaporizes to facilitate deterioration of the frying oil.

Further, in order to increase the number of times of repeated use of the frying oil, the frying oil is also passed through a strainer when the frying oil is discharged from the oil tank into the oil recovery tank, and thus fried scraps are removed by the strainer. In order to strain out fine fried scraps floating in the frying oil by the strainer, it is required that the strainer have a satisfactorily fine-meshed filter. However, when the filter is fine-meshed, it takes a lot of time for the frying oil to pass through the filter, and that amount of time is required for cleaning work. In addition, there has been still a fear in that the moisture contained in the frying oil is not removed by the filter and is stirred with the frying oil in the oil recovery tank.

### SUMMARY OF THE INVENTION

The present invention has been made in view of the problems as described above, and has an object to provide a fryer that is capable of collecting, even when a large amount of moisture released from a food material during frying is contained in a frying oil without vaporizing, the moisture in a reserve tank without returning the moisture to an oil tank, and that is capable of preventing oxidative deterioration of the frying oil even in repeated use of the frying oil.

That is, according to the present invention, there is provided a fryer, which is configured to heat a frying oil stored in an oil tank by a heater so as to fry a food material put into the oil tank, the fryer including: an upper oil tank in which the heater is arranged and the food material is to be fried; a lower oil tank, which is provided below the upper oil tank so as to be continuous with the upper oil tank, includes a discharge port formed in a deepest portion to discharge fried scraps generated in the oil tank, together with the frying oil, and includes a plurality of inclined bottom plates inclined toward the discharge port; a water-cooling jacket, which is provided around the lower oil tank and filled with cooling water, and is configured to forcibly cool the frying oil in the lower oil tank; a discharge valve configured to open and close a discharge flow path leading to the discharge port; a reserve tank configured to store the frying oil flowing down from the oil tank through the discharge valve; and a return flow path in which an oil feed pump is provided, and through which the frying oil in the reserve tank is to be fed into the lower oil tank. Further, the reserve tank includes a filter provided at a top of the reserve tank and configured to remove the fried scraps from the frying oil flowing into the reserve tank, and a bottom plate in the reserve tank is inclined toward a deepest portion serving as a reservoir for the frying oil. A suction pipe leading to the return flow path is arranged in the reservoir, and a distal end of the suction pipe is arranged at a distance from the bottom plate of the reserve tank.

According to the present invention, the bottom plate of the reserve tank is inclined toward the reservoir being the deepest portion, and hence when the frying oil is discharged from the oil tank into the reserve tank, the moisture contained in the frying oil gradually gathers in the reservoir inside the reserve tank. Further, the distal end of the suction pipe for returning the frying oil from the reserve tank to the oil tank is arranged in the reservoir at a distance from the bottom plate, and hence when the oil feed pump is driven to suck up the frying oil from the reserve tank, part of the frying oil is left in the reserve tank without being returned to the oil tank. As a result, the moisture contained in the frying oil in the reserve tank remains in the reservoir in the state of being gathered in the reservoir without being sucked up by the suction pipe.

That is, when the frying oil containing the moisture is temporarily discharged from the oil tank into the reserve tank, and then the frying oil is fed again from the reserve tank into the oil tank, the moisture contained in the frying oil can be collected in the reserve tank. As a result, deterioration of the frying oil due to oxidation can be prevented as much as possible even in repeated use of the frying oil.

### BRIEF DESCRIPTION OF THE DRAWINGS

FIG. 1 is a schematic sectional view for illustrating an example of an embodiment of a fryer to which the present invention is applied.

FIG. 2 is a block diagram for illustrating a control system of the fryer according to the embodiment.

FIG. 3 is a front view for illustrating a reserve tank of the fryer according to the embodiment.

FIG. 4 is a side view for illustrating the reserve tank of the fryer according to the embodiment.

FIG. 5 is a plan view for illustrating the reserve tank of the fryer according to the embodiment.

### DESCRIPTION OF THE EMBODIMENTS

Now, a fryer according to the present invention is described in detail with reference to the attached drawings.

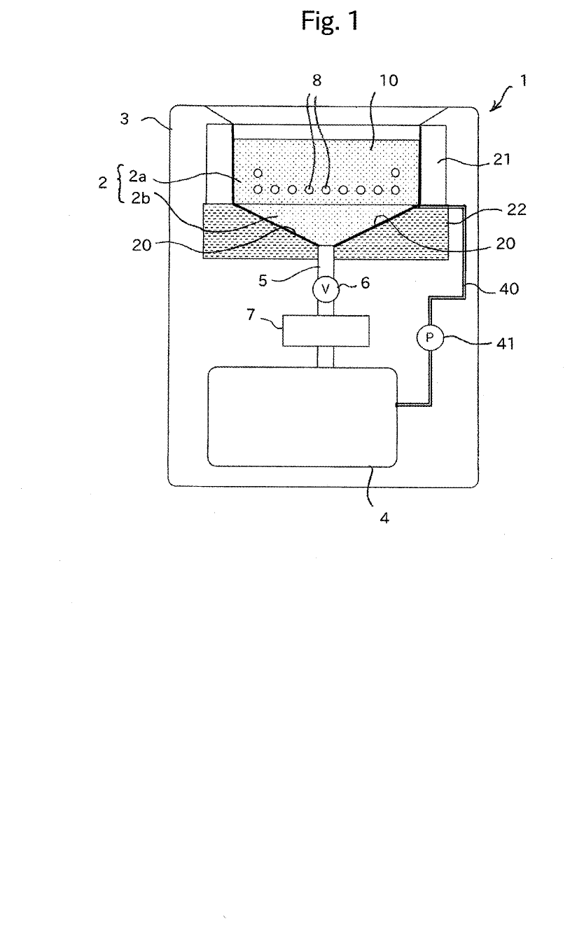

FIG. 1 is a view for illustrating an example of a professional-use fryer to which the present invention is applied. A fryer 1 is a freestanding type fryer to be used in, for example, kitchens of restaurant stores, and can perform frying under a state in which about 18 liters of a frying oil 10 is put into an oil tank.

The fryer 1 includes an oil tank 2 that stores a frying oil, a housing 3 that supports the oil tank 2, a reserve tank 4 housed in the housing 3 below the oil tank 2, and a discharge flow path 5 through which the frying oil is to be discharged from the oil tank 2 to the reserve tank 4. A discharge valve 6 is provided in the discharge flow path 5, and is configured to cause the frying oil in the oil tank 2 to flow by its own weight into the reserve tank 4 when the discharge valve 6 is opened.

Further, a mesh filter 7 is provided in the middle of the route for discharging the frying oil from the discharge flow path 5 into the reserve tank 4. When the frying oil flowing toward the reserve tank 4 passes through the filter 7, fried scraps are collected by the filter 7. As for coarseness of the filter, a mesh filter of from 20 mesh to 50 mesh is applicable, and a mesh filter of from 30 mesh to 40 mesh is preferred. Depending on a wire diameter of a wire forming the filter, for example, a mesh size of 50 mesh is about 0.279 mm, and hence fine particulate fried scraps pass through the filter. The reason why the filter 7 has a coarse mesh to collect only large fried scraps as described above is to set a flow rate per unit time of the frying oil 10 passing through the filter 7 to be high, and to thus quickly discharge the frying oil 10 in the oil tank 2 into the reserve tank 4. The details of the reserve tank 4 are described later.

The oil tank 2 includes an upper oil tank 2a in which frying is performed, and a lower oil tank 2b, which is provided below the upper oil tank 2a so as to be continuous with the upper oil tank 2a. A heater 8 that heats the frying oil is provided in the upper oil tank 2a, and the frying oil in the upper oil tank 2a can be heated to any appropriate temperature by energizing the heater 8. Meanwhile, a discharge port connected to the discharge flow path 5 is formed in a deepest portion of the lower oil tank 2b. A plurality of inclined bottom plates 20 are arranged around the discharge port so as to be inclined toward the discharge port, and those inclined bottom plates 20 are joined together to form a bottom plate of the oil tank 2. In the illustrated example, four inclined bottom plates 20 are arranged around the discharge port so that the bottom plate of the oil tank 2 has a shape of an inverted quadrangular pyramid.

Further, a periphery of the upper oil tank 2a is covered with a heat insulating material 21, whereas a water-cooling jacket 22 filled with cooling water is provided around the lower oil tank 2b. Thus, when the heater 8 is energized, the frying oil 10 in the upper oil tank 2a, which is provided with the heater 8 and covered with the heat insulating material 21, is heated to a high temperature (for example, 180°C). Meanwhile, the frying oil 10 in the lower oil tank 2b is forcibly cooled by the water-cooling jacket 22, and the frying oil 10 in the lower oil tank 2b is kept at a low temperature of less than 100°C (for example, 60°C). Although not shown, a supply pipe and a discharge pipe for cooling water are connected to the water-cooling jacket 22. The cooling water that has been increased in temperature due to cooling of the lower oil tank 2b can be discharged to the outside through the discharge pipe, and new low-temperature cooling water can be supplied through the supply pipe.

A food material is fried in the upper oil tank 2a in which the frying oil is heated by the heater 8. Meanwhile, moisture and fried scraps released from the food material into the frying oil during frying sink from the upper oil tank 2a into the lower oil tank 2b. As described above, the frying oil 10 in the lower oil tank 2b is kept at a low temperature of less than 100°C, and hence the moisture that has reached an inside of the lower oil tank 2b sinks to the vicinity of the inclined bottom plates 20 without vaporizing. Further, the temperature of the frying oil 10 in the lower oil tank 2b is significantly lower than that in the upper oil tank 2a, and hence there is no convection of the frying oil from the lower oil tank 2b to the upper oil tank 2a, with the result that the fried scraps that have sunk in the lower oil tank 2b do not rise into the upper oil tank 2a but deposit on the plurality of inclined bottom plates 20.

Meanwhile, a return flow path 40 is provided between the reserve tank 4 and the oil tank 2, and the frying oil 10 present in the reserve tank 4 can be appropriately fed into the oil tank 2 by driving an oil feed pump 41. The return flow path 40 is connected to the oil tank 2 below the heater 8, more specifically, connected above upper ends of the inclined bottom plates 20 of the lower oil tank 2b and at a boundary portion between the upper oil tank 2a and the lower oil tank 2b.

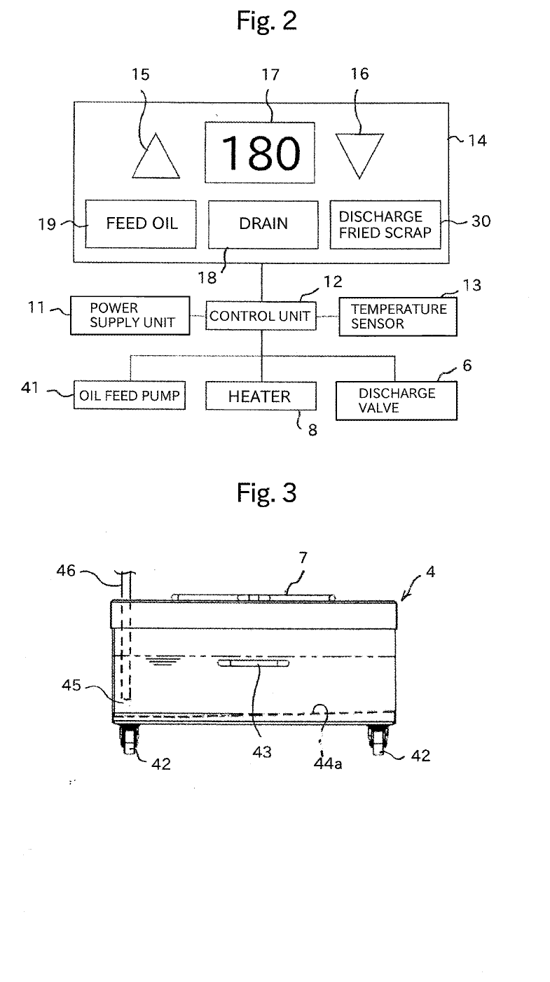

FIG. 2 is a block diagram for illustrating a control system of this fryer 1. This fryer 1 includes a power supply unit 11 to which power is supplied from an AC power source, and a control unit 12 with a built-in microprocessor receives power from the power supply unit 11 to control operations of the oil feed pump 41, the heater 8, and the discharge valve 6. Further, a temperature sensor 13 that measures the temperature of the frying oil 10 in the upper oil tank 2a is connected to the control unit 12. In order that the frying oil 10 in the upper oil tank 2a is kept at a predetermined temperature (for example, 180°C), with reference to an output signal of the temperature sensor 13 at predetermined time intervals, the control unit 12 instructs the power supply unit 11 to supply power to the heater 8 in accordance with a program stored in advance.

An operation panel 14 serving as a user interface is connected to the control unit 12. The operation panel 14 includes an UP button 15 and a DOWN button 16 for inputting a cooking temperature, and a display unit 17 that shows a current temperature of the frying oil 10 in the upper oil tank 2a and the cooking temperature set through use of the UP button 15 and the DOWN button 16.

Further, the operation panel 14 includes a drain button 18 for instructing discharging of a total volume of the frying oil 10 in the oil tank 2 into the reserve tank 4, and also includes an oil feed button 19 for filling the empty oil tank 2 with the frying oil 10 in the reserve tank 4. The drain button 18 is operated, for example, when it is desired to empty the oil tank 2 and clean the oil tank 2. When the button 18 is operated, the discharge valve 6 is opened, and the total volume of the frying oil 10 in the oil tank 2 is discharged into the reserve tank 4. The oil feed button 19 is operated when it is desired to transfer the frying oil 10 in the reserve tank 4 into the empty oil tank 2. When the button 19 is operated, the oil feed pump 41 is activated to feed substantially the total volume of the frying oil 10 in the reserve tank 4 into the oil tank 2, thereby being capable of filling the oil tank 2 with the frying oil 10.

In addition, when the used frying oil 10 in the oil tank 2 is replaced with a new oil, after the used frying oil 10 is discharged into the reserve tank 4 by operating the drain button 18, the frying oil in the reserve tank 4 is replaced with a new frying oil, and by further operating the oil feed button 19, the oil tank 2 can be filled with the new frying oil 10. In this manner, a user can easily perform replacement work of the frying oil 10 without lifting a heavy container containing the frying oil 10.

The operation panel 14 includes a fried scrap discharge button 30 for discharging the fried scraps having deposited in the lower oil tank 2b out of the oil tank 2 while frying is carried out in the oil tank 2. When a user operates the fried scrap discharge button 30, the control unit 12 opens the discharge valve 6 for a predetermined time period, and the frying oil 10 in the lower oil tank 2b is discharged toward the reserve tank 4 by a predetermined amount (for example, about 4 liters). Further, in conjunction therewith, the control unit 12 activates the oil feed pump 41 to feed the frying oil 10 in the reserve tank 4 into the oil tank 2.

FIG. 3 to FIG. 5 are views for illustrating details of the reserve tank 4.

The reserve tank 4 is formed into a rectangular shape, and includes casters 42 on a bottom surface thereof, and a handle 43 on a front surface thereof. The reserve tank 4 can be easily pulled out from a lower part of the housing 3 under a state in which a large amount of frying oil is stored in the reserve tank 4. A capacity of the reserve tank 4 is set larger than the total volume of the frying oil 10 in the oil tank 2, and is set to about 26 liters in this embodiment. The above-mentioned filter 7 is provided at a center of the top of the reserve tank 4. The frying oil 10 discharged from the oil tank 2 passes through the filter 7, and flows into the reserve tank 4, and thus the fried scraps are collected by the filter 7. The filter 7 includes a grip 70 so that only the filter 7 can be removed from the reserve tank 4, and hence the collected fried scraps can be disposed of.

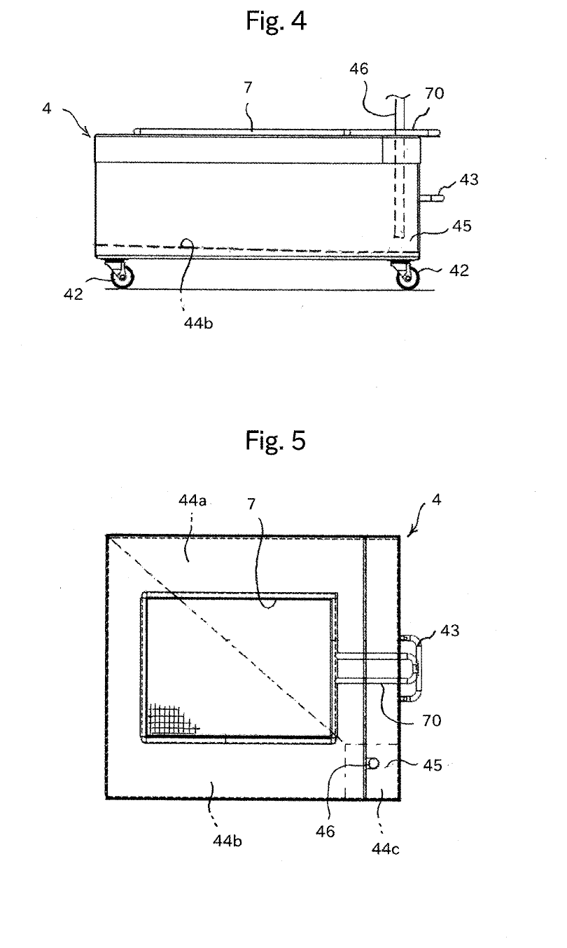

A bottom plate in the reserve tank 4 includes a bottom plate 44a inclined toward a left of the reserve tank 4 as illustrated in the front view of FIG. 3, a bottom plate 44b inclined toward a front of the reserve tank 4 as illustrated in the side view of FIG. 4, and a horizontal bottom plate 44c provided at a left end of a front side of the reserve tank 4 as illustrated in the plan view of FIG. 5. The bottom plate 44c is the deepest portion of the reserve tank 4, and functions as a reservoir 45 in which the frying oil 10 in the reserve tank 4 first gathers and also gathers until the end. That is, as the volume of the frying oil 10 in the reserve tank 4 decreases, the frying oil 10 flows over the bottom plates 44a and 44b and gathers in the reservoir 45.

A suction pipe 46 leading to the return flow path 40 is inserted into the reserve tank 4. This suction pipe 46 is arranged in the reservoir 45, and a distal end of the suction pipe 46 is arranged at a distance from the bottom plate 44c of the reserve tank 4. In this structure, even when the oil feed pump 41 is activated, the frying oil in the reserve tank 4 is not completely sucked up, and hence a slight amount of the frying oil remains in the reservoir. Further, the suction pipe 46 is provided in the reserve tank 4 in a freely removable manner, and is removed from the reserve tank 4 when the reserve tank 4 is to be pulled out from the housing 3 toward the front side.

Further, the reserve tank 4 always retains the frying oil 10 enough to be fed into the lower oil tank 2b when the fried scrap discharge button 30 is operated, and such frying oil 10 is present in the reservoir 45. This is why the capacity of the reserve tank 4 is set larger than the capacity of the oil tank 2.

As described above, when the drain button 18 or the fried scrap discharge button 30 is operated, the frying oil 10 in the oil tank 2 is discharged into the reserve tank 4, and at that time, the fried scraps having deposited on the inclined bottom plates 20 in the lower oil tank 2b are discharged from the oil tank 2 together with the frying oil 10. Relatively large fried scraps mixed in the discharged frying oil 10 are collected by the filter 7, but fine fried scraps and moisture flow into the reserve tank 4 in the state of being mixed in the frying oil 10 without being collected by the filter 7.

The fine fried scraps and moisture mixed in the frying oil settle on the bottom plates of the reserve tank 4 as the frying oil 10 is stored in the reserve tank 4. For example, when a user presses the drain button 18 on the operation panel 14 after the end of the day's work, the frying oil 10 is discharged from the oil tank 2 into the reserve tank 4, and at the same time, the oil feed pump 41 is driven for a predetermined time period to perform cleaning of the oil tank 2 with the frying oil circulated from the reserve tank 4 to the oil tank 2. When the frying oil 10 discharged into the reserve tank 4 is retained in the reserve tank 4 as it is until the next morning, the fine fried scraps and the moisture settle on the bottom plates of the reserve tank 4 at the time when the work is started the next day. In this case, the fried scraps deposit on the bottom plates 44a, 44b, and 44c of the reserve tank. Meanwhile, the bottom plates 44a and 44b are inclined, and hence the moisture, which has a larger specific gravity than the frying oil, flows over the bottom plates 44a and 44b and gathers on the bottom plate 44c being the deepest portion of the reserve tank 4.

At the time when the work is started the next day, a user can return the frying oil 10 in the reserve tank 4 to the oil tank 2 by pressing the oil feed button 19 on the operation panel 14. In this case, when the oil feed pump 41 operates, the frying oil in the reserve tank 4 is sucked out into the return flow path 40 by means of the suction pipe 46 arranged in the reservoir 45, and fed into the oil tank 2 through the return flow path 40.

Meanwhile, the suction pipe 46 for returning the frying oil 10 from the reserve tank 4 to the oil tank 2 has the distal end arranged at a distance from the bottom plate 44c, and a predetermined distance (for example, 5 mm) is provided between the suction pipe 46 and the bottom plate 44c. Thus, when the oil feed pump 41 is driven to suck up the frying oil 10 from the reserve tank 4, at least part of the frying oil 10 present in the reservoir 45 is left in the reserve tank 4 without being returned to the oil tank 2. As a result, the moisture contained in the frying oil 10 in the reserve tank 4 remains in the reservoir 45 in the state of being gathered in the reservoir 45 without being sucked up by the suction pipe 46.

That is, in the fryer 1 according to this embodiment, when the frying oil 10 containing the moisture is temporarily discharged from the oil tank 2 into the reserve tank 4 and then, after a certain time interval, is fed from the reserve tank 4 into the oil tank 2, the moisture contained in the frying oil 10 remains in the reservoir of the reserve tank 4, and hence only the frying oil, from which the moisture has been removed, can be fed from the reserve tank 4 into the oil tank 2.

In particular, the fryer 1 according to this embodiment has a structure in which the lower oil tank 2b is surrounded by the water-cooling jacket 22, and thus the moisture released into the frying oil 10 from the food material during frying is easily collected in the lower oil tank 2b without vaporizing. By that amount, the moisture contained the frying oil discharged from the oil tank into the reserve tank is increased. Accordingly, as described above, when only the frying oil, from which the moisture has been removed, can be fed from the reserve tank 4 into the oil tank 2 while the moisture contained in the frying oil 10 is left in the reservoir of the reserve tank 4, the moisture released from the food material can be actively gathered in the reserve tank 4 without vaporizing the moisture in the oil tank 2. As a result, vaporization of the moisture in the oil tank can be prevented, and deterioration of the frying oil due to oxidation can be prevented as much as possible, thereby being capable of extending a life cycle of the frying oil and thus reducing cost of frying.

Further, the distal end of the suction pipe is arranged at a distance from the bottom plate 44c, and hence the fine fried scraps having deposited on the bottom plates 44a, 44b, and 44c of the reserve tank 4 are not fed into the oil tank together with the frying oil.

As described above, according to the fryer 1 of the present invention, when the frying oil 10 used in the oil tank 2 for frying is temporarily discharged into the reserve tank 4, and then is fed again from the reserve tank 4 into the oil tank 2, the moisture released into the frying oil 10 from the food material during frying can be removed in the reserve tank 4. Accordingly, oxidative deterioration of the frying oil 10 during frying can be prevented as much as possible, thereby being capable of prolonging the life cycle of the frying oil 10 until replacement and thus reducing cost of frying.

What is claimed is:

1. A fryer, which is configured to heat a frying oil stored in an oil tank by a heater so as to fry a food material put into the oil tank, the fryer comprising:
an upper oil tank in which the heater is arranged, and the food material is to be fried;
a lower oil tank, which is provided below the upper oil tank so as to be continuous with the upper oil tank, includes a discharge port formed in a deepest portion to discharge fried scraps generated in the oil tank, together with the frying oil, and includes a plurality of inclined bottom plates inclined toward the discharge port;
a water-cooling jacket, which is provided around the lower oil tank and filled with cooling water, and is configured to forcibly cool the frying oil in the lower oil tank;
a discharge valve configured to open and close a discharge flow path leading to the discharge port;
a reserve tank configured to store the frying oil flowing down from the oil tank through the discharge valve; and
a return flow path in which an oil feed pump is provided, and through which the frying oil in the reserve tank is to be fed into the lower oil tank,
wherein the reserve tank includes a filter provided at a top of the reserve tank and configured to remove the fried scraps from the frying oil flowing into the reserve tank, and a bottom plate in the reserve tank is inclined toward a deepest portion serving as a reservoir for the frying oil, and
wherein a suction pipe leading to the return flow path is arranged in the reservoir, and a distal end of the suction pipe is arranged at a distance from the bottom plate of the reserve tank.

2. The fryer according to claim 1, wherein the reserve tank includes casters so as to be allowed to be pulled out from below the oil tank, and the suction pipe is provided in the reserve tank in a freely removable manner.

3. The fryer according to claim 1, wherein the filter is provided in the reserve tank in a freely removable manner.
